(19) United States
(12) Patent Application Publication
(10) Pub. No.: US 2024/0163029 A1
(43) Pub. Date: May 16, 2024

(54) METHOD AND APPARATUS FOR TRANSMITTING HYBRID AUTOMATIC REPEAT REQUEST ACKNOWLEDGEMENT INFORMATION, AND MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/281,284

(22) PCT Filed: Mar. 23, 2021
(86) PCT No.: PCT/CN2021/082477

§ 371 Date: Sep. 8, 2023

(51) Int. Cl. H04L 1/1829

(52) U.S. Cl. CPC H04L 1/1864

(57) ABSTRACT

The present disclosure provides a method and apparatus for transmitting hybrid automatic repeat request (HARD) acknowledgement (ACK) information, and a medium. The method comprises: in response to the number D of orthogonal frequency-division multiplexing (OFDM) symbols occupied in the time domain by a control resource set corresponding to a PDCCH being greater than 3, sending HARQ-ACK to a network device after a first duration of the end moment of the last OFDM symbol of a physical downlink shared channel (PDSCH), where the first duration is related to the number D of OFDM symbols occupied in the time domain by the control resource set corresponding to the PDCCH.

### CROSS-REFERENCE TO RELATED APPLICATION

The application is the U.S. National Stage of International Application No. PCT/CN2021/082477 filed on Mar. 23, 2021, the entire content of which is incorporated herein by reference for all purposes.

### TECHNICAL FIELD

The present disclosure relates to the technical field of wireless communications, and in particular, to a method and apparatus for transmitting hybrid automatic repeat request-ack (HARQ-ACK), and a readable storage medium.

### BACKGROUND

Currently, in new radio (NR), downlink data is carried on a physical downlink shared channel (PDSCH), and uplink data is carried on a physical uplink shared channel (PUSCH). The base station schedules PDSCH and PUSCH through downlink control information (DCI) carried on a physical downlink control channel (PDCCH).

After receiving the PDCCH, User Equipment (UE) needs to demodulate the scheduling DCI carried in the PDCCH first, and then can correctly receive the PDSCH or PUSCH scheduled by the DCI.

### SUMMARY

The embodiments of the present disclosure provide a method and apparatus for transmitting hybrid automatic repeat request-ack (HARQ-ACK), and a readable storage medium.

In a first aspect, the present disclosure provides a method for transmitting HARQ-ACK, where the method is performed by a user equipment, or performed by a chip in the user equipment. The user equipment may be a mobile phone.

The method includes: in response to a number D of OFDM symbols occupied by a control resource set corresponding to a PDCCH in a time domain being greater than 3, after a first duration following an end time of a last orthogonal frequency division multiplexing (OFDM) symbol of a physical downlink shared channel (PDSCH), sending a HARQ-ACK to a network device, where the first duration is related to the number D of OFDM symbols occupied by the control resource set corresponding to the PDCCH in the time domain.

In a second aspect, the present disclosure provides a method for transmitting HARQ-ACK, where the method is performed by a network device or performed by a chip in the network device. The network devices may include an access network device, such as a base station, a nodeB, and the like.

The method includes: in response to a number D of OFDM symbols occupied by a control resource set corresponding to a PDCCH in a time domain being greater than 3, after a first duration following an end time of a last orthogonal frequency division multiplexing (OFDM) symbol of a physical downlink shared channel (PDSCH), receiving a HARQ-ACK from a user equipment; where the first duration is related to the number D of OFDM symbols occupied by the control resource set corresponding to the PDCCH in the time domain.

In a third aspect, the present application provides a communication apparatus. The communication apparatus may be configured to perform the steps performed by the user equipment in the first aspect or any possible design of the first aspect. The user equipment may implement each function in the above-mentioned methods in the form of a hardware structure, a software module, or a hardware structure plus a software module.

When the communication apparatus shown in the third aspect is implemented by a software module, the communication apparatus may include a communication module and a processing module coupled with each other, where the communication module can be configured to support the communication apparatus to communicate, and the processing module can be configured to perform processing operations by the communication apparatus, such as generating information/messages to be sent, or processing received signals to obtain information/messages.

When performing the steps described in the first aspect above, the transceiver module is configured to, in response to that the number D of OFDM symbols occupied by the control resource set corresponding to the PDCCH in the time domain is greater than 3, after the first duration after the end time of the last orthogonal frequency division multiplexing (OFDM) symbol of the physical downlink shared channel (PDSCH), send the HARQ-ACK to the network device, where the first duration is related to the number D of OFDM symbols occupied by the control resource set corresponding to the PDCCH in the time domain.

In a fourth aspect, an embodiment of the present application provides a communication apparatus. The communication apparatus may be configured to perform the steps performed by the network device in the second aspect or any possible design of the second aspect. The network device may implement each function in the above-mentioned methods in the form of a hardware structure, a software module, or a hardware structure plus a software module.

When the communication apparatus shown in the fourth aspect is implemented by a software module, the communication apparatus may include a communication module and a processing module coupled with each other, where the communication module can be configured to support the communication apparatus to communicate, and the processing module can be configured to perform processing operations by the communication apparatus, such as generating information/messages to be sent, or processing received signals to obtain information/messages.

When performing the steps described in the second aspect above, the transceiver module is configured to, in response to the number D of OFDM symbols occupied by the control resource set corresponding to the PDCCH in the time domain being greater than 3, after the first duration after the end time of the last OFDM symbol of the physical downlink shared channel (PDSCH), receive the HARQ-ACK from the user equipment, where the first duration is related to the number D of OFDM symbols occupied by the control resource set corresponding to the PDCCH in the time domain.

In a fifth aspect, the present disclosure provides a communication system, which may include the communication apparatus shown in the third aspect and the communication apparatus shown in the fourth aspect. The communication apparatus shown in the third aspect may be composed of software modules and/or hardware components. The communication apparatus shown in the fourth aspect may be composed of software modules and/or hardware components.

In a sixth aspect, the present disclosure provides a communication apparatus, including a processor and a memory; the memory is configured to store a computer program; and the processor is configured to execute the computer program to implement the first aspect or any one of possible designs of the first aspect.

In a seventh aspect, the present disclosure provides a communication apparatus, including a processor and a memory; the memory is configured to store a computer program; and the processor is configured to execute the computer program to implement the second aspect or any one of possible designs of the second aspect.

In an eighth aspect, the present disclosure provides a computer-readable storage medium, where instructions (or computer programs, programs) are stored in the computer-readable storage medium, which, when invoked and executed on a computer, cause the computer to execute the above-mentioned first aspect or any possible design of the first aspect.

In a ninth aspect, the present disclosure provides a computer-readable storage medium, where instructions (or computer programs, programs) are stored in the computer-readable storage medium, which, when invoked and executed on a computer, cause the computer to execute the above-mentioned second aspect or any possible design of the second aspect.

For the beneficial effects of the above-mentioned second to ninth aspects and possible designs thereof, reference may be made to the description of the beneficial effects of the method in the first aspect and any possible designs thereof.

It is to be understood that the foregoing general description and the following detailed description are exemplary and explanatory only and are not restrictive of the present disclosure.

### BRIEF DESCRIPTION OF THE DRAWINGS

FIG. 1 is a structural diagram of a wireless communication system according to an embodiment;

FIG. 2 is a flowchart of a method for transmitting HARQ-ACK according to an embodiment;

FIG. 3 is a structural diagram of an apparatus for transmitting HARQ-ACK according to an embodiment;

FIG. 4 is a structural diagram of another apparatus for transmitting HARQ-ACK according to an embodiment;

FIG. 5 is a structural diagram of another apparatus for transmitting HARQ-ACK according to an embodiment;

FIG. 6 is a structural diagram of another apparatus for transmitting HARQ-ACK according to an embodiment.

### DETAILED DESCRIPTION

The embodiments of the present disclosure are further explained in conjunction with the accompanying drawings and specific implementations. Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the embodiments of the present disclosure. Instead, they are merely examples of apparatuses and methods consistent with some aspects of the present disclosure as recited in the appended claims.

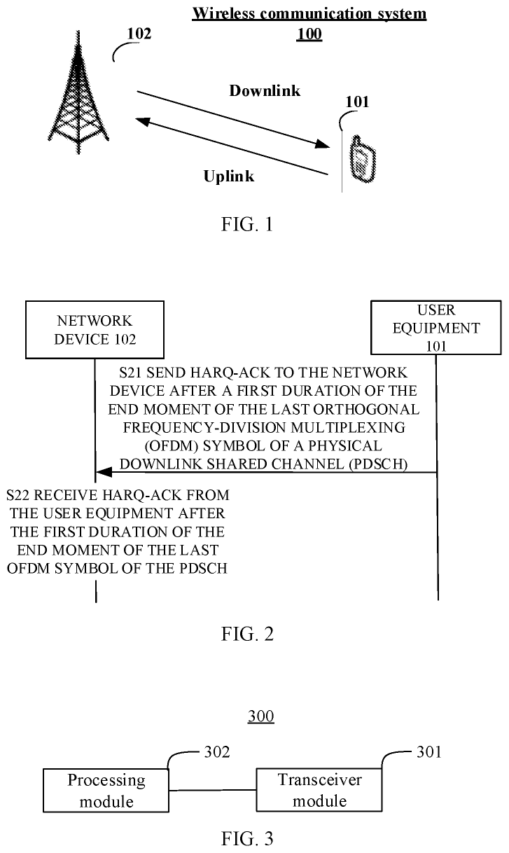

As shown in FIG. 1, the method for transmitting hybrid automatic repeat request information provided by the embodiment of the present application may be applied to a wireless communication system 100, and the wireless communication system may include a terminal device 101 and a network device 102. The terminal device 101 is configured to support carrier aggregation, and the terminal device 101 may be connected to a plurality of carrier units of the network device 102, including one primary carrier unit and one or more secondary carrier units.

It should be understood that the above wireless communication system 100 is applicable to both a low frequency scenario (sub 60 GHz) and a high frequency scenario (above 60 GHz). The application scenarios of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The terminal device 101 shown above may be a user equipment (UE), a terminal (terminal), an access terminal, a terminal unit, a terminal station, a mobile station (MS), a remote station, a remote terminal, a mobile terminal, a wireless communication device, a terminal agent or a terminal device, etc. The terminal device 101 may have a wireless transceiver function, which can communicate (such as wireless communication) with one or more network devices of one or more communication systems, and accept a network service provided by the network device, where the network device includes, but is not limited to, the shown network device 102.

The terminal device 101 may be a cellular phone, a cordless phone, a session initiation protocol (SIP) phone, a wireless local loop (WLL) station, a personal digital assistant (PDA) device, a handheld device with wireless communication functions, a computing device or other processing devices connected to wireless modems, an in-vehicle device, a wearable device, a terminal device in future 5G networks or a terminal device in future evolved PLMN networks, etc.

The network device 102 may be an access network device (or called an access network point). The access network device refers to a device that provides a network access function, such as a radio access network (RAN) base station, and the like. The network device 102 may specifically include a base station (B S), or include a base station and a radio resource management device for controlling the base station, and the like. The network device 102 may also include a relay station (relay device), an access point, a base station in a future 5G network, a base station in a future evolved PLMN network, or an NR base station, and the like. The network device 102 may be a wearable device or a vehicle-mounted device. The network device 102 may also be a communication chip with a communication module.

For example, the network device 102 includes, but is not limited to: a base station based on any generation of communication technology, a next-generation base station (gnodeB, gNB) in 5G, an evolved node B (eNB) in the LTE system, a radio network controller (RNC), a node B (NB) in WCDMA system, a wireless controller in the CRAN system, a base station controller (BSC), a base transceiver station (BTS) in GSM system or CDMA system, a home base station (for example, home evolved node B, or home node B, HNB), a baseband unit (BBU), a transmission point (transmitting and receiving point, TRP), a transmitting point (TP) or a mobile switching center, etc.

Taking NR as an example, the terminal device 101 can process the PDCCH in the following manner: the terminal device 101 monitors the PDCCH sent by the network device 102 in one or more search spaces (SSs) to receive downlink control information (DCI) carried by the PDCCH. In all embodiments of the present disclosure, for the sake of simplicity, the downlink control information may also be referred to as control information; and the control information may include, but is not limited to, DCI. The SS is the set of candidate locations where the terminal device 101 needs to monitor the PDCCH. The SS includes a common search space (CSS) and a UE specific search space (USS), and NR introduces the concept of control resource set (CORESET) for PDCCH. One CORESET is a candidate time-frequency resource for the terminal device 101 to attempt to detect the PDCCH using one or more SSs, and the CORESET may include a plurality of consecutive resource blocks in the frequency domain and a plurality of consecutive symbols in the time domain. The time-frequency position of CORESET may be located at any position of the BWP and one slot. The time domain and frequency domain positions of CORESET may be semi-statically configured by the network device 102 side through high layer signaling.

The resources used by one PDCCH are composed of one or more CCEs aggregated in one CORESET, and the number of one or more CCEs corresponds to the AL of the PDCCH. In the related art, there is a corresponding relationship between the aggregation level of the PDCCH supported by the NR and the number of CCEs used by the PDCCH. One CCE may be composed of 6 resource element groups (REGs), and each REG includes one symbol in the time domain and one resource block (RB) in the frequency domain. One of the RBs may include 12 resource-elements (REs) in the frequency domain. When monitoring one PDCCH sent by the network device 102, the terminal device 101 needs to perform detection according to each possible aggregation level of the PDCCH at the candidate position of each PDCCH configured by the network device 102. Therefore, when the aggregation level of the PDCCH is unknown, the terminal device 101 monitors each candidate position multiple times. In the high frequency band (such as the frequency band around 60 GHz), in order to deal with the phase noise, it is usually chosen to use a relatively large subcarrier spacing, such as 960 KHz. A larger subcarrier interval corresponds to a smaller duration (the duration is the duration of a slot), for example: when the subcarrier interval is 960 KHz, the corresponding duration of one slot is 1/64 millisecond (ms), and in this relatively short duration, the UE may not be able to perform monitoring for the PDCCH channel in every slot.

In the embodiment of the present disclosure, a multi-slot PDCCH monitoring pattern is introduced, and a multi-slot group corresponding to PDCCH monitoring is introduced in this pattern. The multi-slot group includes a plurality of time-domain units, the multi-slot PDCCH monitoring span includes a plurality of time-domain units, and the time-domain unit is one slot or half a slot. In the multi-slot PDCCH monitoring pattern, not all time-domain units in one multi-slot group are configured with PDCCH, but some time-domain units are configured with PDCCH, for example: one slot or several slots in the multi-slot group are configured with PDCCH, and other slots are not configured with PDCCH. A slot configured with the PDCCH may be referred to as a PDCCH slot. In this multi-slot PDCCH monitoring pattern, the PDCCH monitoring capability is defined in units of multi-slot group.

In one slot, the number D of OFDM symbols occupied in the time domain by the control resource set (CORESET) corresponding to one PDCCH channel can also be called a CORESET duration. The CORESET duration may be 3 orthogonal frequency division multiplexing (OFDM) symbols.

The PDSCH processing duration T_{proc,1} is used to represent the minimum duration for demodulating PDSCH and generating HARQ-ACK. The PDSCH processing duration T_{proc,1} may be calculated according to the following formula (1), wherein N₁, d_{1,1} and d₂ are respectively integers, κ, μ, T_{C}, and Tₑₓₜ are respectively real numbers:

T_{proc,1}=(N₁+d_{1,1}+d₂)(2048+144)·κ2^{-μ}·T_{C}+Tₑₓₜ (1)

Since the introduction of a multi-slot group corresponding to PDCCH monitoring may lead to a reduction in the slots corresponding to the PDCCH, a possible enhancement way is to increase the CORESET duration, that is, to increase the number D of OFDM symbols occupied in the time domain by the control resource set corresponding to one PDCCH channel. This enhancement way will affect the PDSCH processing duration T_{proc,1}.

In view of the fact that the user equipment 101 needs to blindly detect the PDCCH or monitor the PDCCH before further demodulating the PDSCH, if the CORESET duration is increased, the duration of blind detection will be affected, thereby affecting the PDSCH processing duration T_{proc,1}.

To sum up, in the case of increasing the CORESET duration, how to determine the PDSCH processing duration T_{proc,1} is a problem that needs to be solved.

Embodiments of the present disclosure provide a method for transmitting HARQ-ACK. FIG. 2 is a flowchart of a method for transmitting HARQ-ACK according to an embodiment. As shown in FIG. 2, the method includes the following steps.

In step S21, in response to a number D of OFDM symbols occupied by a control resource set corresponding to a PDCCH in a time domain being greater than 3, the user equipment 101 sends a HARQ-ACK to the network device 102 after a first duration after or following an end time of the last orthogonal frequency division multiplexing (OFDM) symbol of the physical downlink shared channel (PDSCH); where the first duration is related to the number D of OFDM symbols occupied by the control resource set corresponding to the PDCCH in the time domain.

In step S22, in response to the number D of OFDM symbols occupied by the control resource set corresponding to the PDCCH in the time domain being greater than 3, the network device 102 receives the HARQ-ACK from the user equipment 101 after a first duration after/following the end time of the last orthogonal frequency division multiplexing (OFDM) symbol of the physical downlink shared channel (PDSCH); where the first duration is related to the number D of OFDM symbols occupied by the control resource set corresponding to the PDCCH in the time domain.

In all embodiments of the present disclosure, the first duration may be determined based on a communication protocol or configured by a base station, and the first duration may be 0 or any number greater than 0.

In the embodiments of the present disclosure, the first duration is related to the CORESET duration, that is, the number D of OFDM symbols occupied by the control resource set corresponding to the PDSCH in the time domain, so that the first duration is more in line with the effect of the increased CORESET duration, and the value of the first duration is more reasonable.

The embodiment of the present disclosure provides a method for transmitting HARQ-ACK, which is performed by the user equipment 101. This method includes:

in response to the number D of OFDM symbols occupied by the control resource set corresponding to the PDCCH in the time domain being greater than 3, after the first duration after/following the end time of the last orthogonal frequency division multiplexing (OFDM) symbol of the physical downlink shared channel (PDSCH), sending a HARQ-ACK to the network device 102; where the first duration is related to the number D of OFDM symbols occupied by the control resource set corresponding to the PDCCH in the time domain.

In all embodiments of the present disclosure, the first duration may be determined based on a communication protocol or configured by a base station, and the first duration may be 0 or any number greater than 0.

When the first duration is 0, the method includes: in response to the number D of OFDM symbols occupied by the control resource set corresponding to the PDCCH in the time domain being greater than 3, after the end time of the last orthogonal frequency division multiplexing (OFDM) symbol of the physical downlink shared channel (PDSCH), sending the HARQ-ACK to the network device 102.

When the first duration is greater than 0, the method includes: in response to the number D of OFDM symbols occupied by the control resource set corresponding to the PDCCH in the time domain being greater than 3, after the first duration after/following the end time of the last orthogonal frequency division multiplexing (OFDM) symbol of the PDSCH, sending the HARQ-ACK to the network device 102.

In the embodiment of the present disclosure, the first duration is related to the CORESET duration, that is, the number D of OFDM symbols occupied by the control resource set corresponding to the PDSCH in the time domain, so that the first duration is more in line with the impact of the increased CORESET duration, and the value of the first duration is more reasonable.

An embodiment of the present disclosure provides a method for transmitting HARQ-ACK, and the method is executed 101 by a user equipment. This method includes:
in response to the number D of OFDM symbols occupied by the control resource set corresponding to the PDCCH in the time domain being greater than 3, after the first duration after/following the end time of the last OFDM symbol of the physical downlink shared channel (PDSCH), sending a HARQ-ACK to the network device; where the first duration is related to the number D of OFDM symbols occupied by the control resource set corresponding to the PDCCH in the time domain; and is also related to at least one of the following parameters:
a mapping type of the PDSCH;
a number L of OFDM symbols occupied by the PDSCH in the time domain;
a number d of overlapped OFDM symbols of the PDCCH and the PDSCH; or
a processing capability of the user equipment.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to at least one of the following parameters:
a mapping type of the PDSCH;
a number L of OFDM symbols occupied by the PDSCH in the time domain;
a number d of overlapped OFDM symbols of the PDCCH and the PDSCH; or
a processing capability of the user equipment.

In an embodiment, the parameters in equation (1) except d_{1,1} are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDSCH in the time domain, and is also related to at least one of a plurality of PDSCH-related parameters, so that the first duration is more in line with the influence of the increased CORESET duration and the influence of the PDSCH-related parameters, and the value of the first duration is more reasonable.

An embodiment of the present disclosure provides a method for transmitting HARQ-ACK, and the method is executed 101 by a user equipment. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain; and is also related to the mapping type of the PDSCH and the number L of OFDM symbols occupied by the PDSCH in the time domain.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁, and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of OFDM symbols occupied by the PDSCH in the time domain.

In an embodiment, the parameters in equation (1) except d_{1,1} are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of PDSCH and the number L of OFDM symbols occupied by the PDSCH in the time domain, so that the first duration is more in line with the impact of the increased CORESET duration, and more in line with the impact of the above two PDSCH-related parameters, and the value of the first duration is more reasonable.

An embodiment of the present disclosure provides a method for transmitting HARQ-ACK, and the method is executed 101 by a user equipment. This method includes:

in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain; and is also related to the mapping type of the PDSCH and the number L of OFDM symbols occupied by the PDSCH in the time domain.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of OFDM symbols occupied by the PDSCH in the time domain.

In an embodiment, the mapping type of the PDSCH is Type A, the number L of OFDM symbols occupied by the PDSCH in the time domain is greater than N, and d_{1,1} is 0.

In another embodiment, the mapping type of the PDSCH is type A, the number L of OFDM symbols occupied by the PDSCH in the time domain is less than N, and d_{1,1} is M; M is an integer greater than 0.

In yet another embodiment, if the mapping type of the PDSCH is type A, and the number L of OFDM symbols occupied by the PDSCH in the time domain is equal to N, then d_{1,1} is 0 or d_{1,1} is M.

The above three embodiments may be implemented independently, or may be implemented together in any possible manner, which is not limited by the embodiments of the present disclosure.

N is an integer greater than 0 and associated with D, and M is an integer greater than 0 and associated with D.

In an embodiment, the parameters in equation (1) except d_{1,1} are the same as defined in 3GPP TS38.214 section 5.3.

In an example, N=4+D; M=4+D−L.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of the PDSCH and the number L of OFDM symbols occupied by the PDSCH in the time domain, and, when the mapping type of the PDSCH is type A, according to the comparison result of the number L of OFDM symbols occupied by the PDSCH in the time domain with N, d_{1,1} has different values, so that the first duration is more in line with the influence of the increased CORESET duration, as well as the influence of the mapping type of PDSCH and the number L of OFDM symbols occupied by PDSCH in the time domain, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain; and is also related to the following parameters:
a mapping type of the PDSCH;
the number L of OFDM symbols occupied by the PDSCH in the time domain;
the number d of overlapped OFDM symbols of the PDCCH and the PDSCH; or
a processing capability of the user equipment.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

In an embodiment, the parameters in equation (1) except d_{1,1} are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of the PDSCH, the number L of OFDM symbols occupied by the PDSCH in the time domain, and the processing capability of the user equipment, so that the first duration is more in line with the impact of the increased CORESET duration, and the impact of the above four PDSCH-related parameters, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device; where the first duration is related to the number D of OFDM symbols occupied by the control resource set corresponding to the PDCCH in the time domain; and the first duration is also related to the PDSCH mapping type, the number L of OFDM symbols occupied by the PDSCH in the time domain, the number d of overlapped OFDM symbols of the PDCCH and the PDSCH, or the processing capability of the user equipment.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and:
the mapping type of the PDSCH is type B, L is located in a set interval, the processing capability of the user equipment is the first capability, and the value of d_{1,1} is D+d;
the mapping type of the PDSCH is type B, L is located in a set interval, the processing capability of the user equipment is the second capability, and the value of d_{1,1} is D.

In an embodiment, the parameters in equation (1) except d_{1,1} are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of the PDSCH, the number L of OFDM symbols occupied by the PDSCH in the time domain, the number d of overlapped OFDM symbols between the PDCCH and the PDSCH, or the processing capability of the user equipment, and when the mapping type of the PDSCH is Type B, when the number L of OFDM symbols occupied by the PDSCH in the time domain is in the set interval, d_{1,1} is set to different values according to the different processing capabilities of the user equipment, so that the first duration is more consistent with the influence of the increased CORESET duration and the influence of the above four PDSCH-related parameters, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain, and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In an embodiment, the parameters other than f in equation (2) are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to at least one of a plurality of PDSCH-related parameters, so that the first duration is more in line with the impact of the increased CORESET duration and the impact of the PDSCH-related parameters, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain, and is also related to the mapping type of the PDSCH and the number L of OFDM symbols occupied by the PDSCH in the time domain.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is also related to the mapping type of the PDSCH and the number L of OFDM symbols occupied by the PDSCH in the time domain.

In an embodiment, the parameters other than f in equation (2) are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of the PDSCH and the number L of OFDM symbols occupied by the PDSCH in the time domain, so that the first duration is more in line with the impact of the increased CORESET duration, and in line with the influence of the mapping type of the PDSCH and the number L of OFDM symbols occupied by the PDSCH in the time domain, and the value of the first duration is more reasonable.

The embodiment of the present disclosure provides a method for transmitting HARQ-ACK, which is performed by the user equipment 101. This method includes:
in response to that the number D of OFDM symbols occupied by the control resource set corresponding to the PDCCH in the time domain is greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain, and is also related to the comparison result of the number L of OFDM symbols occupied by the PDSCH in the time domain with N; where N is determined according to the number D of OFDM symbols.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is also related to the mapping type of the PDSCH and the number L of OFDM symbols occupied by the PDSCH in the time domain.

In an embodiment, the mapping type of the PDSCH is type A, the number L of OFDM symbols occupied by the PDSCH in the time domain is greater than N, and f is 0.

In another embodiment, the mapping type of the PDSCH is type A, the number L of OFDM symbols occupied by the PDSCH in the time domain is less than N, and f is M; M is an integer greater than 0.

In yet another embodiment, if the mapping type of the PDSCH is type A, and the number L of OFDM symbols occupied by the PDSCH in the time domain is equal to N, then f is 0 or f is M.

The above three embodiments may be implemented independently, or may be implemented together in any possible manner, which is not limited by the embodiments of the present disclosure.

N is an integer greater than 0 and associated with D, and M is an integer greater than 0 and associated with D.

In an embodiment, the parameters other than f in equation (2) are the same as defined in 3GPP TS38.214 section 5.3.

In an example, N=4+D; M=4+D−L.

In the embodiment of the present disclosure, the first duration T_{proc,1} is related to the CORESET duration, that is, the number D of OFDM symbols occupied by the control resource set corresponding to the PDCCH in the time domain, and is also related to the mapping type of the PDSCH and the number L of OFDM symbols occupied by the PDSCH in the time domain, and when the comparison result of the number L of OFDM symbols occupied by the PDSCH in the time domain with N is different, f is taken a different value, so that the first first duration is more in line with the influence of the increased CORESET duration, as well as the influence of the mapping type of the PDSCH and the number L of OFDM symbols occupied by the PDSCH in the time domain, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain; and is related to the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to the following parameters:

the mapping type of the PDSCH;

the number L of OFDM symbols occupied by the PDSCH in the time domain;

the number d of overlapped symbols of the PDCCH and the PDSCH; or

the processing capability of the user equipment.

In an embodiment, the parameters other than f in equation (2) are the same as defined in 3GPP TS38.214 section 5.3.

In the embodiment of the present disclosure, the first duration T_{proc,1} is related to the CORESET duration, that is, the number D of OFDM symbols occupied by the control resource set corresponding to the PDCCH in the time domain, and is also related to the above four PDSCH-related parameters, so that the first duration is more in line with the influence of the increased CORESET duration and the influence of the PDSCH-related parameters, and the value of the first duration is more reasonable.

The embodiment of the present disclosure provides a method for transmitting HARQ-ACK, which is performed by the user equipment 101. This method includes:
in response to the number D of OFDM symbols occupied by the control resource set corresponding to the PDCCH in the time domain being greater than 3, after the first duration after the end time of the last OFDM symbol of the physical downlink shared channel (PDSCH), sending a HARQ-ACK to the network device 102; where the first duration is related to the number D of OFDM symbols occupied by the control resource set corresponding to the PDCCH in the time domain; and is related to the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

The mapping type of the PDSCH is type B, L is located in a set interval, the processing capability of the user equipment is the first capability, and the value of f is D+d.

The mapping type of the PDSCH is type B, L is located in a set interval, the processing capability of the user equipment is the second capability, and the value of f is D.

In an embodiment, the parameters other than f in equation (2) are the same as defined in 3GPP TS38.214 section 5.3.

In an example, the set interval is [2, 4].

In the embodiment of the present disclosure, the first duration T_{proc,1} is related to the CORESET duration, that is, the number D of OFDM symbols occupied by the control resource set corresponding to the PDCCH in the time domain, and is also related to the above four PDSCH-related parameters, so that the first duration is more in line with the influence of the increased CORESET duration and the influence of the PDSCH-related parameters, and the value of the first duration is more reasonable.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving a HARQ-ACK from the user equipment 101; where the first duration is related to the number D of OFDM symbols occupied by the control resource set corresponding to the PDCCH in the time domain.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving a HARQ-ACK from the user equipment 101; where the first duration is related to the number D of OFDM symbols occupied by the control resource set corresponding to the PDCCH in the time domain; and is also related to at least one of the following parameters:
a mapping type of the PDSCH;
the number L of OFDM symbols occupied by the PDSCH in the time domain;
the number d of overlapped OFDM symbols of the PDCCH and the PDSCH; or
a processing capability of the user equipment.

In some embodiments,
the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁, d_{1,1} and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to at least one of the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

In an embodiment, the parameters in equation (1) except d_{1,1} are the same as defined in 3GPP TS38.214 section 5.3.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving HARQ-ACK from the user equipment; where the first duration is related to the number D of OFDM symbols occupied by the control resource set corresponding to the PDCCH in the time domain, and is also related to the mapping type of PDSCH and the number L of the OFDM symbols occupied by the PDSCH in the time domain.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)

where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of the OFDM symbols occupied by the PDSCH in the time domain.

In an embodiment, the parameters in equation (1) except d_{1,1} are the same as defined in 3GPP TS38.214 section 5.3.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving a HARQ-ACK from the user equipment; where the first duration is related to the number D of OFDM symbols occupied by the control resource set corresponding to the PDCCH in the time domain, and is also related to the mapping type of the PDSCH and the number L of OFDM symbols occupied by the PDSCH in the time domain.

In some embodiments, the first duration T_{proc,1} is determined by the following formula (1):

T_{proc,1}=(N₁+d_{1,1}+d₂)(2048+144)·κ2^{-μ}·T_{C}+Tₑₓₜ (1)

where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of OFDM symbols occupied by the PDSCH in the time domain.

In some embodiments, the mapping type of the PDSCH is type A, the number L of OFDM symbols occupied by the PDSCH in the time domain is greater than an integer N, and d_{1,1} is 0.

In some embodiments, the mapping type of the PDSCH is type A, the number L of OFDM symbols occupied by the PDSCH in the time domain is less than the integer N, d_{1,1} is M; M is an integer greater than 0.

In yet another embodiment, if the mapping type of the PDSCH is type A, and the number L of OFDM symbols occupied by the PDSCH in the time domain is equal to N, then d_{1,1} is 0 or d_{1,1} is M.

The above three embodiments may be implemented independently, or may be implemented together in any possible manner, which is not limited by the embodiments of the present disclosure.

N is an integer greater than 0 and associated with D, and M is an integer greater than 0 and associated with D.

In an embodiment, the parameters in equation (1) except d_{1,1} are the same as defined in 3GPP TS38.214 section 5.3.

In an example, N=4+D; M=4+D−L.

Embodiments of the present disclosure provide a method for transmitting HARQ-ACK, which is performed by the network device 102. This method includes:
in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving HARQ-ACK from the user equipment; where the first duration is related to the number D of OFDM symbols occupied by the control resource set corresponding to the PDCCH in the time domain; and is also related to the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

In some embodiments,
the first duration T_{proc,1} is determined by the following formula (1):

T_{proc,1}=(N₁+d_{1,1}+d₂)(2048+144)·κ2^{-μ}·T_{C}+Tₑₓₜ (1)

where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

In an embodiment, the mapping type of the PDSCH is type B, L is located in a set interval, the processing capability of the user equipment is the first capability, and the value of d_{1,1} is D+d;
the mapping type of the PDSCH is type B, L is located in a set interval, the processing capability of the user equipment is the second capability, and the value of d_{1,1} is D.

In an embodiment, the parameters in equation (1) except d_{1,1} are the same as defined in 3GPP TS38.214 section 5.3.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving HARQ-ACK from the user equipment 101; where the first duration is related to the number D of OFDM symbols occupied by the control resource set corresponding to the PDCCH in the time domain; and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In an embodiment, the parameters other than f in equation (2) are the same as defined in 3GPP TS38.214 section 5.3.

Embodiments of the present disclosure provide a method for transmitting HARQ-ACK, which is performed by the network device 102. This method includes:

in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving a HARQ-ACK from the user equipment 101; where the first duration is related to the number D of OFDM symbols occupied by the control resource set corresponding to the PDCCH in the time domain, and is also related to the PDSCH mapping type and the number L of OFDM symbols occupied by the PDSCH in the time domain.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is also related to the mapping type of the PDSCH and the number L of OFDM symbols occupied by the PDSCH in the time domain.

In an embodiment, the mapping type of the PDSCH is type A, the number L of OFDM symbols occupied by the PDSCH in the time domain is greater than N, and f is 0.

In another embodiment, the mapping type of the PDSCH is type A, the number L of OFDM symbols occupied by the PDSCH in the time domain is less than N, and f is M; M is an integer greater than 0.

In yet another embodiment, if the mapping type of the PDSCH is type A, and the number L of OFDM symbols occupied by the PDSCH in the time domain is equal to N, then f is 0 or f is M.

The above three embodiments may be implemented independently, or may be implemented together in any possible manner, which is not limited by the embodiments of the present disclosure.

N is an integer greater than 0 and associated with D, and M is an integer greater than 0 and associated with D.

In an embodiment, the parameters other than f in equation (2) are the same as defined in 3GPP TS38.214 section 5.3.

In an example, N=4+D; M=4+D−L.

Embodiments of the present disclosure provide a method for transmitting HARQ-ACK, which is performed by the network device 102. This method includes:
in response to the number D of OFDM symbols occupied by the control resource set corresponding to the PDCCH in the time domain being greater than 3, after the first duration after the end time of the last orthogonal frequency division multiplexing (OFDM) symbol of the physical downlink shared channel (PDSCH), receiving a HARQ-ACK from the user equipment 101; where the first duration is related to the number D of OFDM symbols occupied by the control resource set corresponding to the PDCCH in the time domain and is related to the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In some embodiments, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

In an implementation manner, the mapping type of the PDSCH is type B, L is located in a set interval, the processing capability of the user equipment is the first capability, and the value of f is D+d.

The mapping type of the PDSCH is type B, L is located in a set interval, the processing capability of the user equipment is the second capability, and the value of f is D. In an embodiment, the parameters other than f in equation (2) are the same as defined in 3GPP TS38.214 section 5.3.

In an example, the set interval is [2, 4].

Based on the same concept as the above method embodiments, the embodiments of the present application further provide a communication apparatus, which can have the function of the network device 102 in the above method embodiments, and can be used to execute the steps performed by the network device 102 provided by the above method embodiments. The function can be implemented by hardware, or can be implemented by software or hardware executing corresponding software. The hardware or software includes one or more modules corresponding to the above function.

In an implementation manner, the communication apparatus 300 shown in FIG. 3 may be used as the network device involved in the above method embodiments, and perform the steps performed by the network device in the above method embodiments. As shown in FIG. 3, the communication apparatus 300 may include a transceiver module 301 and a processing module 302, and the transceiver module 301 and the processing module 302 are coupled to each other. The transceiver module 301 can be used to support the communication apparatus 300 to communicate, and the transceiver module 301 can have a wireless communication function, for example, can perform wireless communication with other communication apparatuses through a wireless air interface. The processing module 302 may be configured to support the communication apparatus 300 to perform the processing actions in the foregoing method embodiments, including but not limited to: generating information, messages to be sent by the transceiver module 301, and/or demodulating and decoding the signals received by the transceiver module 301, and so on.

When performing the steps implemented by the network device 102, the transceiver module 301 is configured to, in response to that the number D of OFDM symbols occupied by the control resource set corresponding to the PDCCH in the time domain is greater than 3, after the first duration after the end time of the last orthogonal frequency division multiplexing (OFDM) symbol of the physical downlink shared channel (PDSCH), receive a HARQ-ACK from the user equipment, where the first duration is related to the number D of OFDM symbols occupied by the control resource set corresponding to the PDCCH in the time domain.

Alternatively, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to at least one of the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

Alternatively, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of the OFDM symbols occupied by the PDSCH in the time domain.

Alternatively, the mapping type of the PDSCH is type A, the number L of OFDM symbols occupied by the PDSCH in the time domain is greater than N, and d_{1,1} is 0;
the mapping type of the PDSCH is type A, the number L of OFDM symbols occupied by the PDSCH in the time domain is less than N, and d_{1,1} is M; M is an integer greater than 0.

Alternatively, the mapping type of the PDSCH is type A, the number L of OFDM symbols occupied by the PDSCH in the time domain is equal to N, and d_{1,1} is 0.

Alternatively, the mapping type of the PDSCH is type A, the number L of OFDM symbols occupied by the PDSCH in the time domain is equal to N, and d_{1,1} is M.

N is an integer greater than 0 and associated with D, and M is an integer greater than 0 and associated with D.

Alternatively, N=4+D; M=4+D−L.

Alternatively, the mapping type of the PDSCH is type B, L is located in a set interval, the processing capability of the user equipment is the first capability, and the value of d_{1,1} is D+d;

the mapping type of the PDSCH is type B, L is located in a set interval, the processing capability of the user equipment is the second capability, and the value of d_{1,1} is D.

Alternatively, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where f is related to the number D of OFDM symbols occupied by the control resource set corresponding to the PDCCH in the time domain; and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

Alternatively, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is also related to the mapping type of the PDSCH and the number L of OFDM symbols occupied by the PDSCH in the time domain.

Alternatively, the mapping type of the PDSCH is type A, the number L of OFDM symbols occupied by the PDSCH in the time domain is greater than or equal to N, and f is 0;
the mapping type of the PDSCH is type A, the number L of OFDM symbols occupied by the PDSCH in the time domain is less than N, and f is M; M is an integer greater than 0.

Alternatively, the mapping type of the PDSCH is type A, the number L of OFDM symbols occupied by the PDSCH in the time domain is equal to N, and f is 0.

Alternatively, the mapping type of the PDSCH is type A, the number L of OFDM symbols occupied by the PDSCH in the time domain is equal to N, and f is M.

N is an integer greater than 0 and associated with D, and M is an integer greater than 0 and associated with D.

In an example, N=4+D; M=4+D−L.

Alternatively, the mapping type of the PDSCH is type B, L is located in a set interval, the processing capability of the user equipment is the first capability, and the value of f is D+d;
the mapping type of the PDSCH is type B, L is located in a set interval, the processing capability of the user equipment is the second capability, and the value of f is D.

In an example, the set interval is [2, 4].

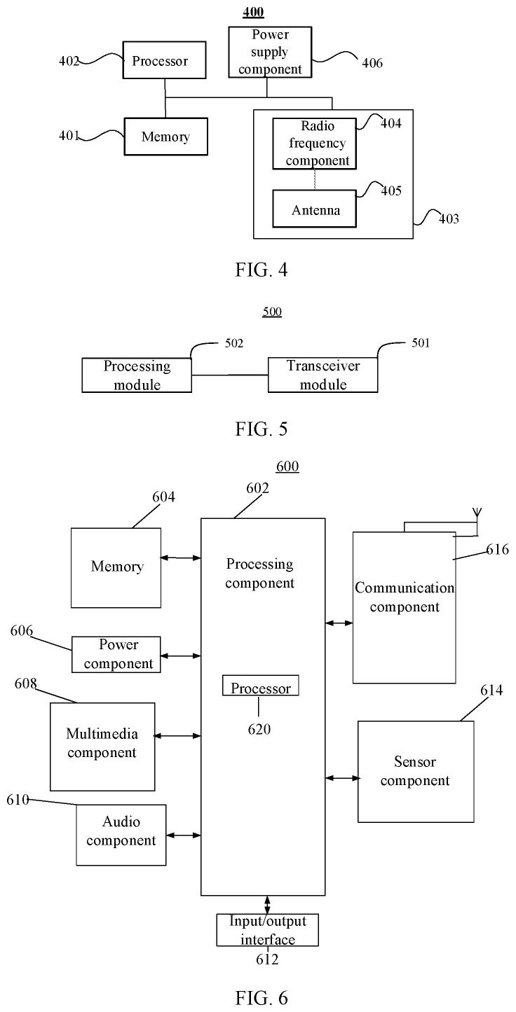

When the communication apparatus is the network device 102, its structure may also be as shown in FIG. 4. The configuration of the communication apparatus will be described by taking a base station as an example. As shown in FIG. 4, the apparatus 400 includes a memory 401, a processor 402, a transceiver component 403, and a power supply component 406. The memory 401 is coupled with the processor 402, and can be used to store programs and data necessary for the communication apparatus 400 to realize various functions. The processor 402 is configured to support the communication apparatus 400 to perform the corresponding functions in the above-mentioned methods, and the functions can be implemented by calling programs stored in the memory 401. The transceiver component 403 may be a wireless transceiver, and may be used to support the communication apparatus 400 to receive signaling and/or data through a wireless air interface, and to transmit signaling and/or data. The transceiver component 403 may also be referred to as a transceiver unit or a communication unit, and the transceiver component 403 may include a radio frequency component 404 and one or more antennas 405, where the radio frequency component 404 may be a remote radio unit (RRU), specifically, it can be used for the transmission of radio frequency signals and the conversion of radio frequency signals and baseband signals, and the one or more antennas 405 can be specifically used for radiation and reception of radio frequency signals.

When the communication apparatus 400 needs to send data, the processor 402 can perform baseband processing on the data to be sent, and then output the baseband signal to the radio frequency unit, and the radio frequency unit performs radio frequency processing on the baseband signal and sends the radio frequency signal through the antenna in the form of electromagnetic waves. When data is sent to the communication apparatus 400, the radio frequency unit receives the radio frequency signal through the antenna, converts the radio frequency signal into a baseband signal, and outputs the baseband signal to the processor 402, and the processor 402 converts the baseband signal into data and processes the data.

Based on the same concept as the above method embodiments, the embodiments of the present application further provide a communication apparatus, which can have the function of the user equipment 101 in the above method embodiments, and can be used to execute the steps performed by the user equipment 101 provided by the above method embodiments. The function can be implemented by hardware, or can be implemented by software or hardware executing corresponding software. The hardware or software includes one or more modules corresponding to the above function.

In an implementation manner, the communication apparatus 500 shown in FIG. 5 may be used as the user equipment involved in the above method embodiments, and perform the steps performed by the user equipment in the above method embodiments. As shown in FIG. 5, the communication apparatus 500 may include a transceiver module 501 and a processing module 502, and the transceiver module 501 and the processing module 502 are coupled to each other. The transceiver module 501 can be used to support the communication apparatus 500 to communicate, and the transceiver module 501 can have a wireless communication function, for example, can perform wireless communication with other communication apparatuses through a wireless air interface. The processing module 502 may be configured to support the communication apparatus 500 to perform the processing actions in the foregoing method embodiments, including but not limited to: generating information, messages to be sent by the transceiver module 501, and/or demodulating and decoding the signals received by the transceiver module 501, and so on.

When performing the steps performed by the user equipment 102, the transceiver module 501 is configured to, in response to that the number D of OFDM symbols occupied by the control resource set corresponding to the PDCCH in the time domain is greater than 3, after the first duration after the end time of the last orthogonal frequency division multiplexed (OFDM) symbol of the physical downlink shared channel (PDSCH), send a HARQ-ACK to the network device; where the first duration is related to the number D of OFDM symbols occupied by the control resource set corresponding to the PDCCH in the time domain.

Alternatively, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to at least one of the following parameters:
the mapping type of the PDSCH;
the number L of OFDM symbols occupied by the PDSCH in the time domain;
the number d of overlapped OFDM symbols of the PDCCH and the PDSCH; or
the processing capability of the user equipment.

Alternatively, the first duration T_{proc,1} is determined by the following formula (1):

T_{proc,1}=(N₁+d_{1,1}+d₂)(2048+144)·κ2^{-μ}·T_{C}+Tₑₓₜ (1)
where N₁ and d₂ are respectively integers, κ, μ, T_{C}, and Tₑₓₜ are respectively real numbers, d_{1,1} is an integer related to the number D of OFDM symbols occupied by the control resource set corresponding to the PDCCH in the time domain, and is also related to the mapping type of the PDSCH and the number L of OFDM symbols occupied by the PDSCH in the time domain.

Alternatively, the mapping type of the PDSCH is type A, the number L of OFDM symbols occupied by the PDSCH in the time domain is greater than or equal to N, and d_{1,1} is 0;
the mapping type of the PDSCH is type A, the number L of OFDM symbols occupied by the PDSCH in the time domain is less than N, and d_{1,1} is M; M is an integer greater than 0;
where N is an integer greater than 0 and associated with D, and M is an integer greater than 0 and associated with D.

Alternatively, N=4+D; M=4+D−L.

Alternatively, the mapping type of the PDSCH is type B, L is located in a set interval, the processing capability of the user equipment is the first capability, and the value of d_{1,1} is D+d;
the mapping type of the PDSCH is type B, L is located in a set interval, the processing capability of the user equipment is the second capability, and the value of d_{1,1} is D.

Alternatively, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is related to at least one of the following parameters:
the mapping type of the PDSCH;
the number L of OFDM symbols occupied by the PDSCH in the time domain;
the number d of overlapped symbols of the PDCCH and the PDSCH; or
the processing capability of the user equipment.

Alternatively, the first duration T_{proc,1} is determined by the following formula (2):

T_{proc,1}=(N₁+d_{1,1}+d₂+f)(2048+144)·κ2^{-μ}·T_{C}+Tₑₓₜ (2)
where N₁, d_{1,1} and d₂ are respectively integers, κ, μ, T_{C}, and Tₑₓₜ are respectively real numbers, f is a real number related to the number D of OFDM symbols occupied by the control resource set corresponding to the PDCCH in the time domain; and is also related to the mapping type of the PDSCH and the number L of OFDM symbols occupied by the PDSCH in the time domain.

Alternatively, the mapping type of the PDSCH is type A, the number L of OFDM symbols occupied by the PDSCH in the time domain is greater than or equal to N, and f is 0;

the mapping type of the PDSCH is type A, the number L of OFDM symbols occupied by the PDSCH in the time domain is less than N, and f is M; M is an integer greater than 0;
where N is an integer greater than 0 and associated with D, and M is an integer greater than 0 and associated with D.

Alternatively, N=4+D; M=4+D−L.

Alternatively, the mapping type of the PDSCH is type B, L is located in a set interval, the processing capability of the user equipment is the first capability, and the value of f is D+d;
the mapping type of the PDSCH is type B, L is located in a set interval, the processing capability of the user equipment is the second capability, and the value of f is D.

Alternatively, the set interval is [2, 4].

It should be understood that the specific process of each module performing the above-mentioned corresponding steps has been described in detail in the above-mentioned method embodiments, and for the sake of brevity, they are not be repeated here.

When the communication apparatus is the user equipment 101, its structure may also be as shown in FIG. 6. The apparatus 600 may be a mobile phone, a computer, a digital broadcast terminal, a messaging device, a gaming console, a tablet, a medical device, exercise equipment, a personal digital assistant, and the like. Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the apparatus 600. Examples of such data include instructions for any applications or methods operated on the apparatus 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power management system, one or more power sources, and any other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 610 is configured to output and/or input audio signals. For example, the audio component 610 includes a microphone (“MIC”) configured to receive an external audio signal when the apparatus 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the apparatus 600. For instance, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600.

The communication component 616 is configured to facilitate communication, wired or wirelessly, between the apparatus 600 and other devices. The apparatus 600 can access a wireless network based on a communication standard, such as WiFi, 2G, or 3G, or a combination thereof. In one embodiment, the communication component 616 receives a broadcast signal or broadcast associated information from an external broadcast management system via a broadcast channel.

In embodiments, the apparatus 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In embodiments, there is also provided a non-transitory computer-readable storage medium including instructions, such as included in the memory 604, executable by the processor 620 in the apparatus 600, for performing the above-described methods. For example, the non-transitory computer-readable storage medium may be a ROM, a RAM, a CD-ROM, a magnetic tape, a floppy disc, an optical data storage device, and the like

Other implementation solutions of the embodiments of the present disclosure will be apparent to those skilled in the art from consideration of the specification and practice of the embodiments disclosed here. The present application is intended to cover any variations, uses, or adaptations of the embodiments of the present disclosure following the general principles thereof and including such departures from the present disclosure as come within known or customary practice in the art. It is intended that the specification and embodiments be considered as exemplary only, with a true scope and spirit of the embodiments of the present disclosure being indicated by the following claims.

It will be appreciated that the embodiments of the present disclosure is not limited to the exact construction that has been described above and illustrated in the accompanying drawings, and that various modifications and changes can be made without departing from the scope thereof. It is intended that the scope of the embodiments of the present disclosure only is limited by the appended claims.

### INDUSTRIAL APPLICABILITY

The first duration is related to the CORESET duration, that is, the number D of OFDM symbols occupied by the control resource set corresponding to the PDSCH in the time domain, so that the first duration is more in line with the increased CORESET duration, making the value of the first duration more reasonable.

1. A method for transmitting hybrid automatic repeat request (HARQ)-acknowledgment (ACK) information, comprising:
in response to a number D of orthogonal frequency division multiplexing (OFDM) symbols being greater than 3, sending, by a user equipment and after a first duration following an end time of a last OFDM symbol of a physical downlink shared channel (PDSCH), a HARQ-ACK to a network device wherein the OFDM symbols are occupied in a time domain by a control resource set corresponding to a physical downlink control channel (PDCCH), and the first duration is related to the number D of the OFDM symbols occupied by the control resource set corresponding to the PDCCH in the time domain.

2. The method for transmitting HARQ-ACK according to claim 1, wherein
the first duration T_{proc,1} is determined by a following formula:
T_{proc,1}=(N₁+d_{1,1}+d₂)(2048+144)·κ2^{-μ}·T_{C}+Tₑₓₜ
wherein N₁ and d₂ are respectively integers, κ, μ, T_{C}, and Tₑₓₜ are respectively real numbers; and wherein d_{1,1} is an integer related to the number D of the OFDM symbols occupied by the control resource set corresponding to the PDCCH in the time domain, and is also related to at least one of following parameters:
a mapping type of the PDSCH;
a number L of OFDM symbols occupied by the PDSCH in the time domain;
a number d of overlapped OFDM symbols of the PDCCH and the PDSCH; or
a processing capability of the user equipment.

3. The method for transmitting HARQ-ACK according to claim 1, wherein
the first duration T_{proc,1} is determined by a following formula:
T_{proc,1}=(N₁+d_{1,1}+d₂)(2048+144)·κ2^{-μ}·T_{C}+Tₑₓₜ
wherein N₁ and d₂ are respectively integers, κ, μ, T_{C}, and Tₑₓₜ are respectively real numbers; and wherein d_{1,1} is an integer related to the number D of the OFDM symbols occupied by the control resource set corresponding to the PDCCH in the time domain, and is also related to a mapping type of the PDSCH and a number L of OFDM symbols occupied by the PDSCH in the time domain.

4. The method for transmitting HARQ-ACK according to claim 3, wherein
the mapping type of the PDSCH is type A, the number L of the OFDM symbols occupied by the PDSCH in the time domain is greater than or equal to an integer N, and d_{1,1} is 0, wherein N is greater than 0 and related to the number D; or,
the mapping type of the PDSCH is type A, the number L of the OFDM symbols occupied by the PDSCH in the time domain is less than the integer N, d_{1,1} is an integer M, the integer M is greater than 0 and related to the number D, and N is greater than 0 and related to the number D.

5. The method for transmitting HARQ-ACK according to claim 4, wherein
N=4+D; M=4+D−L.

6. The method for transmitting HARQ-ACK according to claim 2, wherein
the mapping type of the PDSCH is type B, L is located in a set interval, the processing capability of the user equipment is a first capability, and a value of d_{1,1} is D+d; or
the mapping type of the PDSCH is type B, L is located in a set interval, the processing capability of the user equipment is a second capability, and a value of d_{1,1} is D.

7. The method for transmitting HARQ-ACK according to claim 1, wherein
the first duration T_{proc, 1} is determined by a following formula:
wherein N₁, d_{1,1} and d₂ are respectively integers, κ, μ, T_{C}, and Tₑₓₜ are respectively real numbers, f is a real number related to the number D of the OFDM symbols occupied by the control resource set corresponding to the PDCCH in the time domain; and is related to at least one of following parameters:
a mapping type of the PDSCH;
a number L of OFDM symbols occupied by the PDSCH in the time domain;
a number d of overlapped symbols of the PDCCH and the PDSCH; or
a processing capability of the user equipment.

8. The method for transmitting HARQ-ACK according to claim 1, wherein
the first duration T_{proc, 1} is determined by a following formula:
T_{proc,1}=(N₁+d_{1,1}+d₂+f)(2048+144)·κ2^{-μ}·T_{C}+Tₑₓₜ
wherein N₁, d_{1,1} and d₂ are respectively integers, κ, μ, T_{C}, and Tₑₓₜ are respectively real numbers, f is a real number related to the number D of the OFDM symbols occupied by the control resource set corresponding to the PDCCH in the time domain; and is also related to a mapping type of the PDSCH and a number L of OFDM symbols occupied by the PDSCH in the time domain.

9. The method for transmitting HARQ-ACK according to claim 8, wherein
the mapping type of the PDSCH is type A, the number L of the OFDM symbols occupied by the PDSCH in the time domain is greater than or equal to an integer N, and f is 0, and N is greater than 0 and related to the number D; or
the mapping type of the PDSCH is type A, the number L of the OFDM symbols occupied by the PDSCH in the time domain is less than the integer N, f is an integer M; the integer M is an integer greater than 0 and related to the number D, and N is greater than 0 and related to the number D.

10. The method for transmitting HARQ-ACK according to claim 9, wherein
N=4+D; M=4+D−L.

11. The method for transmitting HARQ-ACK according to claim 7, wherein
the mapping type of the PDSCH is type B, L is located in a set interval, the processing capability of the user equipment is a first capability, and a value of f is D+d; or
the mapping type of the PDSCH is type B, L is located in a set interval, the processing capability of the user equipment is a second capability, and a value of f is D.

12. The method for transmitting HARQ-ACK according to claim 11, wherein
the set interval is [2, 4].

13. A method for transmitting hybrid automatic repeat request (HARQ)-acknowledgment (ACK) information, performed by a network device, comprising:
in response to a number D of orthogonal frequency division multiplexing (OFDM) symbols being greater than 3, receiving, by a network device, after a first duration following an end time of a last OFDM symbol of a physical downlink shared channel (PDSCH), a HARQ-ACK from a user equipment, wherein the OFDM symbols are occupied by a control resource set corresponding to a physical downlink control channel (PDCCH) in a time domain, and the first duration is related to the number D of the OFDM symbols occupied by the control resource set corresponding to the PDCCH in the time domain.

14. The method for transmitting HARQ-ACK according to claim 13, wherein
the first duration T_{proc,1} is determined by a following formula:
T_{proc,1}=(N₁+d_{1,1}+d₂)(2048+144)·κ2^{-μ}·T_{C}+Tₑₓₜ
wherein N₁ and d₂ are respectively integers, κ, μ, T_{C}, and Tₑₓₜ are respectively real numbers; d_{1,1} is an integer related to the number D of the OFDM symbols occupied by the control resource set corresponding to the PDCCH in the time domain, and is also related to at least one of following parameters:
a mapping type of the PDSCH;
a number L of OFDM symbols occupied by the PDSCH in the time domain;
a number d of overlapped OFDM symbols of the PDCCH and the PDSCH; or
a processing capability of the user equipment.

15. The method for transmitting HARQ-ACK according to claim 13, wherein
the first duration T_{proc,1} is determined by a following formula:
T_{proc,1}=(N₁+d_{1,1}+d₂)(2048+144)·κ2^{-μ}·T_{C}+Tₑₓₜ
wherein N₁ and d₂ are respectively integers, κ, μ, T_{C}, and Tₑₓₜ are respectively real numbers; d_{1,1} is an integer related to the number D of the OFDM symbols occupied by the control resource set corresponding to the PDCCH in the time domain, and is also related to a mapping type of the PDSCH and a number L of OFDM symbols occupied by the PDSCH in the time domain.

16.-18. (canceled)

19. The method for transmitting HARQ-ACK according to claim 13, wherein
the first duration T_{proc,1} is determined by a following formula:
T_{proc,1}=(N₁+d_{1,1}+d₂+f)(2048+144)·κ2^{-μ}·T_{C}+Tₑₓₜ
wherein N₁, d_{1,1} and d₂ are respectively integers, κ, μ, T_{C}, and Tₑₓₜ are respectively real numbers, f is a real umber related to the number D of the OFDM symbols occupied by the control resource set corresponding to the PDCCH in the time domain; and is related to at least one of following parameters:
a mapping type of the PDSCH;
a number L of OFDM symbols occupied by the PDSCH in the time domain;
a number d of overlapped symbols of the PDCCH and the PDSCH; or,
a processing capability of the user equipment.

20. The method for transmitting HARQ-ACK according to claim 2413, wherein
the first duration T_{proc,1} is determined by a following formula:
T_{proc,1}=(N₁+d_{1,1}+d₂+f)(2048+144)·κ2^{-μ}·T_{C}+Tₑₓₜ
wherein N₁, d_{1,1} and d₂ are respectively integers, κ, μ, T_{C}, and Tₑₓₜ are respectively real numbers, f is a real number related to the number D of the OFDM symbols occupied by the control resource set corresponding to the PDCCH in the time domain; and is also related to the mapping type of the PDSCH and the number L of the OFDM symbols occupied by the PDSCH in the time domain.

21.-22. (canceled)

23. The method for transmitting HARQ-ACK according to claim 19, wherein
the mapping type of the PDSCH is type B, L is located in a set interval, the processing capability of the user equipment is a first capability, and a value of f is D+d; or
the mapping type of the PDSCH is type B, L is located in a set interval, the processing capability of the user equipment is a second capability, and a value of f is D.

24.-26. (canceled)

27. A communication apparatus, comprising:
a processor and a memory;
wherein
the memory is configured to store a computer program; and
the processor is configured to execute the computer program to implement:
in response to a number D of orthogonal frequency division multiplexing (OFDM) symbols being greater than 3, sending, after a first duration following an end time of a last OFDM symbol of a physical downlink shared channel (PDSCH), a HARQ-ACK to a network device, wherein the OFDM symbols are occupied in a time domain by a control resource set corresponding to a physical downlink control channel (PDCCH), and the first duration is related to the number D of the OFDM symbols occupied by the control resource set corresponding to the PDCCH in the time domain.

28. A communication apparatus, comprising:
a processor and a memory,
wherein
the memory is configured to store a computer program; and
the processor is configured to execute the computer program to implement the method according to claim 13.

29.-30. (canceled)
